(19) United States
(12) Patent Application Publication
(10) Pub. No.: US 2010/0121575 A1
(43) Pub. Date: May 13, 2010

(54) Systems and methods for aerial system collision avoidance

(75) Inventors: Don Aldridge, Odenton, MD (US); Kirk Falk, Severna Park, MD (US)

Correspondence Address: OLIFF & BERRIDGE, PLC, P.O. BOX 320850, ALEXANDRIA, VA, 22320-4850, US

(73) Assignee: ARINC INC., ANNAPOLIS, MD (US)

(21) Appl. No.: 11/699,449

(22) Filed: Jan. 30, 2007

Related U.S. Application Data
(60) Provisional application No. 60/788,722, filed on Apr. 4, 2006.

(51) Int. Cl. G08G 5/04

(52) U.S. Cl. 701/301

(57) ABSTRACT

A ground-based data collection, fusion, analysis and communication system and method are provided to effect collision avoidance for unmanned aerial systems. These systems and methods levy minimal demands on the very strict payload size, weight, and power constraints of many unmanned aerial system platforms by providing an off-board, rather than onboard, sensor system and data fusion capability supporting data acquisition and data fusion from a full spectrum of available sensors. These systems and methods include a capability for high-speed all-source data fusion and analysis with an objective of providing advisory information to a remotely-located pilot of an unmanned aerial system in a timely enough manner for the pilot to effect evasive maneuvers in situations to avoid collision between the unmanned aerial system and conflicting aerial traffic. Additionally, evasive maneuvering commands may be provided directly to an unmanned aerial system based on collected, fused and analyzed data from multiple sources in order to effect autonomous collision avoidance maneuvering within the unmanned aerial system.

### INCORPORATION BY REFERENCE

This application claims priority to U.S. Provisional Patent Application No. 60/788,722 entitled “NUCAS,” filed on Apr. 4, 2006. The disclosure of the prior application is hereby incorporated herein by reference in its entirety.

### BACKGROUND

This disclosure is directed to systems and methods for implementing a collision avoidance capability in unmanned aerial systems.

Unmanned aerial systems (UAS) are being built and deployed at a rapidly accelerating rate in response to military, law enforcement and other agency or individual surveillance requirements. A drawback to broadest employment of UAS platforms in many scenarios stems from not having a pilot onboard able to (1) detect close and/or conflicting aerial traffic and/or (2) effect maneuvers to avoid collision based on visual- or sensor-detected proximity to such conflicting aircraft. As a result, such systems in current employment are involved in an increasing number of serious safety-related incidents, including near and actual midair collision between UAS platforms and conventional aircraft operating in close proximity to one another in both controlled and uncontrolled airspace environments.

Traffic detection and avoidance problems present themselves almost daily in areas of heavy UAS deployment such as, for example, in military missions flown in forward theaters of operation. Future UAS deployment is envisioned to fulfill growing military, law enforcement and other specific aerial surveillance and monitoring requirements that are envisioned to be undertaken in, among other areas, the U.S. National Airspace System (NAS) and in other controlled and uncontrolled airspace. Employment scenarios may include, but are not limited to, border patrol surveillance, rural aerial law enforcement surveillance, and myriad commercial uses such as, for example, pipeline monitoring. In fact, use of UAS platforms in law enforcement, homeland security and such commercial applications promises to prove fruitful if certain shortfalls in the systems deployed today can be overcome. Specifically, an assured Collision Avoidance (CA) capability must be incorporated and demonstrated.

The U.S. Federal Aviation Administration (FAA), for example, has levied a requirement that UAS platforms must have a demonstratable CA capability with an Equivalent Level Of Safety (ELOS) to a manned aircraft before being certified to fly in the NAS. In order to meet this requirement, substantial investment has been made to support research into UAS-based, i.e., “on aircraft,” CA technologies. There exist a variety of sensors and/or sensor arrays that are conventionally employed to detect, track and/or report information regarding aerial traffic. Manned aircraft are provided with myriad active and passive sensors to self-detect conflicting aerial traffic. Such systems augment, or are augmented by, a specific aircrew's ability to see-and-avoid proximate conflicting aerial traffic. Extensive communication capabilities are also incorporated into manned aircraft in order that traffic separation may be implemented by communication with ground-based and/or airborne radar or other sensor capable facilities. These latter capabilities, however, should not be construed, as currently fielded and employed, as providing CA. In fact, there is a distinct difference between capabilities that manage aerial traffic in the NAS providing “traffic separation” and assuring CA. CA is ultimately left, in the case of manned aerial vehicles, to the aircrew operating those vehicles. It is this distinction between traffic separation and CA that forms a basis for the requirement for an ELOS in the employment of a UAS in the NAS.

When the individual aircrew, or man-in-the-loop, is removed from the system in the transition from a manned aircraft to a UAS, the ability of the aircrew to see-and-avoid conflicting aerial traffic is removed. The see-and-avoid capability, therefore, must be replaced in UAS platforms by a Sense-and-Avoid (SAA) capability. Such a capability must be responsive enough to detect conflicting aerial traffic and analyze the potential conflict. The analysis must be quick and accurate enough to (1) provide cues to a remote pilot of the UAS to initiate evasive maneuvers, or (2) provide command guidance to the UAS such that the UAS will autonomously initiate such evasive maneuvers in response to commands.

Drawbacks in the modification and employment of traditional aircraft-based systems to provide CA in UAS platforms include the following. First, none of the individually-deployed systems currently employed in manned aircraft are considered comprehensive enough to provide the necessary ELOS absent an aircrew in the cockpit. Second, even were such shortfalls overcome by, for example, providing sensor arrays and communication systems capable of timely responding at less than a given threshold such that the FAA would certify those systems as having an ELOS, payload size, weight and power (SWAP) requirements to support such systems generally make them incompatible with the very strict SWAP constraints incumbent in most current UAS applications.

Examples of systems technologies that have been, and are being, considered to provide SAA capability that the FAA will consider to have an ELOS to manned aircraft, as discussed above, include, for example, UAS-based radar detection and transmission systems. Other systems may include those that can detect and fuse information from aircraft transponder and/or airframe-mounted traffic alert and collision avoidance systems (TCAS), particularly those including transponder mode S and/or automatic dependent surveillance-broadcast (ADS-B) capabilities. Optical technologies via airframe mounted camera systems, to include low-light level and infra-red capabilities, and acoustic and/or laser ranging systems, are also being studied as candidates for modification and optimization in UAS applications. All of these potential on aircraft solutions to the SAA problem in UAS platforms present difficulties in that any onboard-mounted system may not only stress the SWAP considerations for the UAS based on the carriage of the sensors alone, but may further stress the SWAP considerations by requiring additional system components to perform rudimentary sensor fusion, and data formatting and transmission of even raw sensor data. Incumbent in a methodology of acquiring data from onboard sensors also is a concern with data latency.

### SUMMARY

Key concerns in any Collision Avoidance (CA) system for a UAS include: (1) space, weight and power (SWAP) requirements versus constraints when equipment is installed on the UAS; (2) the ability to operate effectively in all weather conditions to which the UAS may be exposed; (3) distances at which conflicting aerial traffic can be detected in order that risk of collision can be assessed and avoided; (4) types of conflicting aircraft that can be detected based on, for example, size of, and/or systems installed within, the conflicting aircraft; (5) ability to communicate threat of conflict with other aircraft to the remotely-located UAS pilot in a timely enough manner for the pilot to effect evasive maneuvers; and (6) ability to reduce separation criteria between conflicting aircraft to a minimal level balancing the need to avoid collision with a need to not unnecessarily modify the flight path of the UAS in operation.

A ground-based SAA system may prove advantageous in eliminating many of the issues and/or attendant shortfalls associated with the full spectrum UAS-based systems under consideration.

It would be advantageous to provide a ground-based data collection, fusion, analysis and communication system by which an ELOS to manned aerial vehicles could be provided for all UAS applications in the NAS. Such a system would levy minimal, if any, demands on the very strict SWAP constraints of many UAS platforms. For this reason, it may be advantageous to use an off-board, rather than onboard, sensor system and data fusion capability in order to avoid burdening the UAS with significant SWAP requirements while supporting data acquisition and data fusion from a full spectrum of available national and/or local sensors.

It would be advantageous, therefore, to provide a ground-based CA system to solve the SAA problem in all UAS platforms operated throughout the NAS. Such a CA system may advantageously include a capability for high-speed, all-source data collection, fusion and analysis with an objective of providing advisory information to a remotely-located pilot of a UAS in a timely enough manner for the pilot to effect evasive maneuvers in situations to avoid collision between the UAS and conflicting aerial traffic. Such a system would replace a pilot's eyes in an aircraft in providing a CA capability that could be certified to meet, for example, FAA requirements.

In various exemplary embodiments, the systems and methods according to this disclosure may provide a ground-based CA system to provide any UAS with an ELOS to a manned aerial vehicle.

In various exemplary embodiments, the systems and methods according to this disclosure may provide a ground-based, vehicle-centric data collection, fusion, analysis and communication capability to provide advisory information to a remotely-located pilot of a plurality of UAS platforms in a timely enough manner to render a collision avoidance decision and to effect evasive maneuvers to avoid collision with conflicting aerial vehicles.

In various exemplary embodiments, evasive maneuvering commands may be provided directly to a UAS based on collected, fused and analyzed data from multiple sources in order to effect autonomous collision avoidance maneuvering within the UAS.

In various exemplary embodiments, the systems and methods according to this disclosure reduce traffic separation criteria commonly employed by the FAA to be disseminated at a speed, which can be proven and certified as providing an ELOS to a manned aerial vehicle, by providing advisory messages and/or direct data link inputs to a UAS pilot, or to a UAS, to respectively provide sufficient warning to effect maneuvering of the UAS, or to allow the UAS to autonomously maneuver, to avoid collision with proximate conflicting aerial vehicles.

In various exemplary embodiments, the systems and methods according to this disclosure may provide timely monitoring and reporting based of data collected from multiple systems of sensors that are routinely employed to monitor air traffic. More than automating airspace, air traffic and air flow control issues, the systems and methods according to this disclosure may provide vehicle-centric collision avoidance information directly to a remotely-located pilot of a UAS or directly to a UAS in order to effect collision avoidance maneuvering when required between the UAS and conflicting aerial vehicle traffic.

In various exemplary embodiments, the systems and methods according to this disclosure may provide complete coverage of the National Airspace System (NAS) in such a manner to encompass all domestic airspace at any altitude within which a UAS may be employed or operated.

In various exemplary embodiments the systems and methods according to this disclosure may rely on ground-based or ground-monitored sensor systems, and ground-based data collection, fusion, analysis and communication systems such that no additional equipment is required to be located onboard a UAS, thereby not adversely affecting SWAP restraints in the UAS.

In various exemplary embodiments, the systems and methods according to this disclosure may provide a unique high-speed data fusion and analysis capability for multi-source sensor data supported by a communication suite that is commensurately fast enough to support a CA task for a UAS operated in the NAS.

These and other features and advantages of the disclosed systems and methods are described in, or apparent from, the following detailed description of various exemplary embodiments.

### BRIEF DESCRIPTION OF THE DRAWINGS

Various exemplary embodiments of disclosed systems and methods will be described, in detail, with reference to the following figures, wherein:

FIG. 1 illustrates an exemplary operating environment within which to implement the systems and methods according to this disclosure;

FIG. 2 illustrates a block diagram of an exemplary embodiment of a ground-based system for effecting collision avoidance determinations with respect to unmanned aerial systems according to this disclosure; and

FIG. 3 is a flowchart illustrating an exemplary method for effecting collision avoidance determinations with respect to unmanned aerial systems according to this disclosure.

### DETAILED DESCRIPTION OF EMBODIMENTS

The following description of various exemplary embodiments of disclosed systems and methods will describe an exemplary ground-based capability for providing collision avoidance (CA) to an unmanned aerial system (UAS) operated within the National Airspace System (NAS) at any altitude at which the UAS may be operated. It should be appreciated, however, that systems and methods as disclosed and described herein are not meant to be limited to any specific embodiment or application. More specifically, disclosed systems and methods are intended to be implementable to provide collision avoidance separation to any air traffic operated in the NAS anywhere and at any time, or in other areas where proper sensor coverage may be provided. It is evident that certain of the portions of the systems and methods as described herein may also find utility in providing collision avoidance detection and warnings for manned aerial vehicles. As such, although this disclosure will focus on UAS platforms, the terms “aerial systems” and/or “airborne aerial systems,” as employed in this disclosure should be understood to include “manned” aerial systems for which the systems and methods according to this disclosure may prove equally advantageous in facilitating collision avoidance. Further, it should be appreciated that the systems and methods according to this disclosure may find utility in other types of vehicles. For this reason, although focused on aerial systems, for the purposes of this disclosure, the term “vehicle” should be considered as being applicable to various alternative modes of travel on land, in the air and on or under the sea.

This disclosure may refer to Federal Aviation Administration (FAA) requirements that domestically-operated UAS platforms will not be deployable until they can demonstrate, and be certified as providing, an Equivalent Level of Safety (ELOS) to manned aircraft. This is an example of a certification criteria that systems and methods according to this disclosure are intended to meet. It should be appreciated, however, that the disclosed systems and methods are not intended to be in any way limited to, or by, such certification criteria.

In various exemplary embodiments, the systems and methods according to this disclosure may provide an off-board system, i.e., not carried by the UAS platform, that may be capable of one or more of the following:
collecting sensor data in a vehicle-centric manner regarding at least one UAS platform and at least one surrounding aerial vehicle that may present potential inflight conflict and/or risk of collision. Such data may include, but not being limited to, position, altitude, heading and speed, all of which data may be obtainable from one or more sensor sources;
collecting and collating flight plan and aircraft inflight reporting information regarding planned and actual routes of flight for air traffic;
fusing collected data and calculating parameters specifically related to collision avoidance that may not be immediately available from any single sensor, or otherwise directly available to the UAS or the UAS pilot;
based on collected sensor data and otherwise reported data, and/or calculated parameters, assessing conflict (risk of collision) between one or more aerial vehicles and one or more UAS platforms; and
communicating warning messages regarding a potential collision threat, based on an assessment, to a locally-situated or remotely-located UAS pilot, and/or directly to a UAS, to facilitate effecting evasive maneuvering of the UAS to reduce the risk of collision.
   The systems and methods according to this disclosure may provide a long-range, high-speed, highly-reliable CA capability in all weather and lighting conditions for all UAS platforms, regardless of size, or onboard sensor capability, operated at any capable altitude within the NAS.

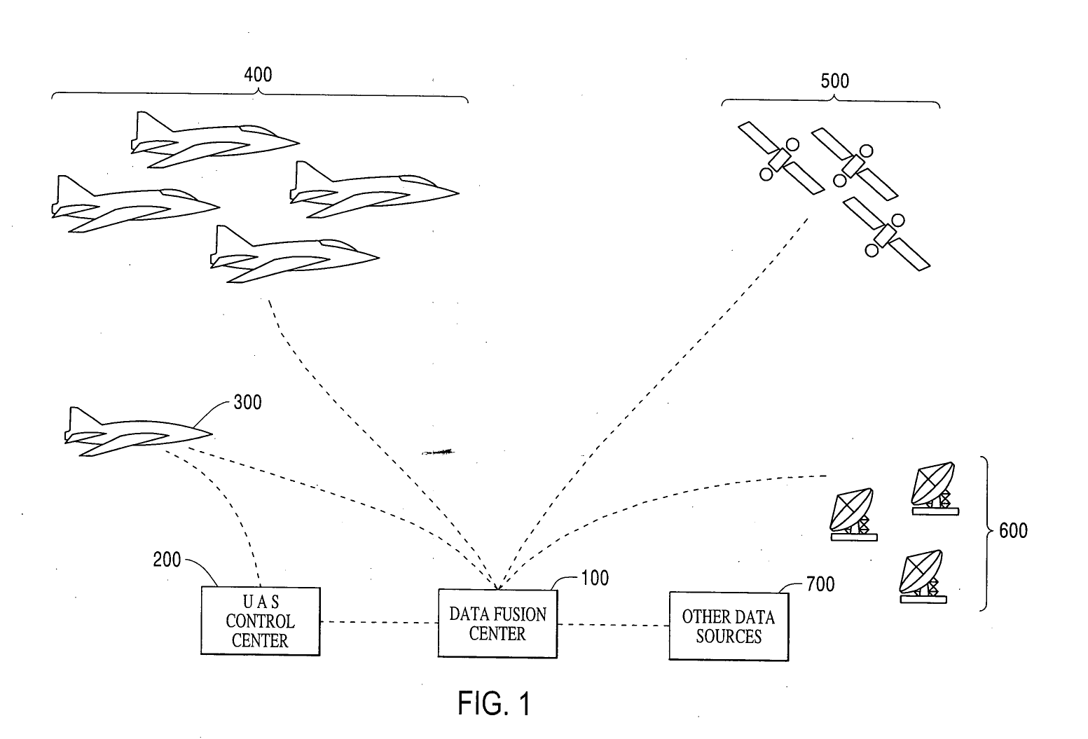

FIG. 1 illustrates an exemplary operating environment within which to implement systems and methods for collision avoidance in a UAS. As shown in FIG. 1, a data fusion center 100 may be available to fuse, collect, and analyze all-source sensor data to provide timely collision avoidance cues through communication to an pilot remotely located in a UAS control center 200 that is “piloting” one or more UAS platforms 300. All-source sensor data collected, fused and analyzed in the data fusion center 100 may be communicated to the UAS controller and/or directly to the UAS platform 300 in order to effect maneuvering to avoid collision with other aerial vehicles 400 operated in proximity to the UAS platform 300.

The all-source sensor data discussed above may include data available from the UAS control center 200, the UAS platform 300, data reporting systems and communication systems located within manned aerial vehicles 400, satellite-sensed data from numerous sources available via satellite communications from one or more satellites 500, radar data available from fixed and/or mobile radar sites 600 and other applicable data regarding aerial traffic in a specific area available from other data sources 700, which may include, but not be limited to, ADS-B, weather reporting stations, airports, flight service stations, and any other like source that may be available to collect and/or report information regarding aircraft movement in a proximity to one or more UAS platforms 300, which may present risk of collision with one or more manned aerial vehicles 400.

Information obtainable from either a UAS 300 or manned aerial vehicles 400 may include automatically reported data, or, in the case of manned aerial vehicles manually, i.e., aircrew, reported data transmitted via communication networks. Such information may include, but not be limited to, position reporting, and altitude, airspeed, heading, vertical velocity, predicted path and/or other like information regarding operating parameters of either the UAS platform 300, or manned aerial vehicles 400 in the vicinity of the UAS platform 300. Information from UAS platforms 300 or manned aerial vehicles 400 may be communicated directly to the data fusion center 100, or may be communicated via other reporting nodes in communication with the UAS platforms 300 or manned aerial vehicles 400 to the data fusion center 100. For example, in the case of a UAS platform 300, information regarding the operating parameters of the UAS platform 300 may be provided to the data fusion center 100 via direct communications with the UAS control center 200 rather than directly from the UAS platform 300.

Data available from satellite sources 500 may include any communicated information regarding aerial traffic that may be routinely, or specifically, communicated via satellite communications (SATCOM) to one or more reporting nodes. Again here, such information may be obtainable by the data fusion center 100 directly from the satellites 500, or otherwise via one or more separate communication nodes in communication with one or more satellites 500 and the data fusion center 100.

Radar data from one or more fixed or mobile radar platforms 600 may be reported directly to the data fusion center 100. Alternatively, agencies controlling individual radar units, groups of radar units or radar surveillance arrays directed at a specific region of airspace within which a UAS platform 300 may be operated may routinely collect and collate radar fusion data from each of the fixed or mobile radar platforms 600 that they control, or are in communication with, and separately report such data to the data fusion center 100. Such agencies may include, but are not limited to, those associated with the Federal Aviation Administration, the Department of Defense, and/or the Department of Homeland Security for monitoring of, for example, U.S. domestic airspace in what is commonly referred to as the NAS.

Other data sources 700 may be broadly construed to encompass any available communicating node with which, for example, aircraft planned, or actual, flight plan data may be provided to the data fusion center 100.

Systems and methods, as will be discussed in greater detail below, may be employed within the data fusion center 100 to collect, fuse, and analyze all-source data received from one or more of the multiple sources discussed above in order that time-critical determinations can be made regarding the risk of collision between at least one UAS platform 300 and one or more manned aerial vehicles 400. Such determinations may in turn be communicated to either or both of a UAS pilot operating one or more UAS platforms 300 from, for example, a UAS control center 200, and one or more UAS platforms 300. For differentiation, a specific UAS platform about which a risk of collision determination is being made regarding all of the above available data may be referred to throughout this disclosure as the “target vehicle.”

In accordance with the above discussion, it should be recognized that the time critical nature of the data collection, fusion, analysis and communication to either a UAS pilot in a UAS control center 200 or directly to a UAS platform 300 in order to effect collision avoidance requires that all-source data be available to the data fusion center 100 in a form that the data fusion center 100 can perform its function to an extent that may be required to, for example, effect an Equivalent Level Of Safety (ELOS) to a manned aerial vehicle. Such a capability may be demonstratable in order to, for example, be certifiable by the FAA to facilitate UAS platform 300 operation in the NAS. Details of the systems and methods to facilitate this data collection, fusion, analysis and communication within and from the data fusion center 100 will be discussed in greater detail below.

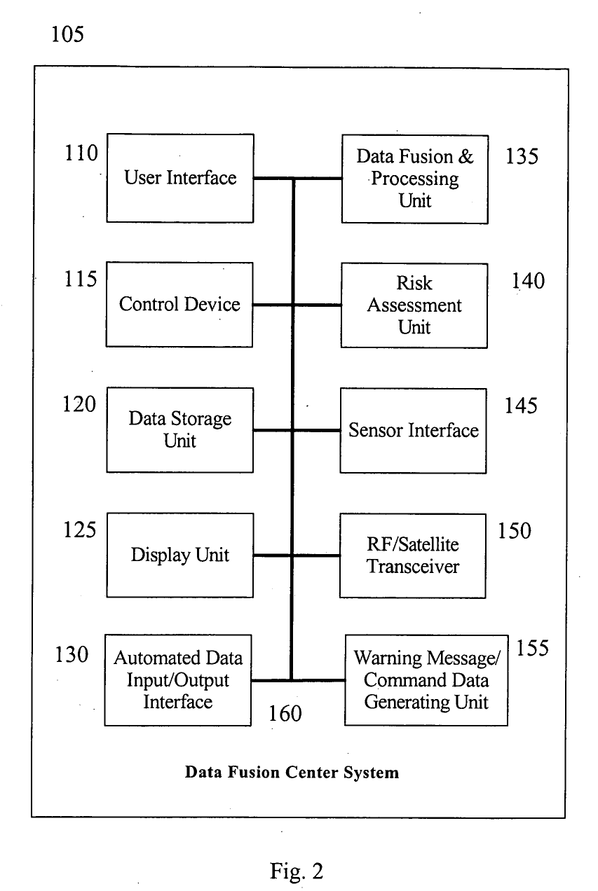

FIG. 2 illustrates a block diagram of an exemplary embodiment of a ground-based data fusion center system 105 for effecting collision avoidance determinations with respect to unmanned aerial systems. As shown in FIG. 2, the exemplary system 105 may include a user interface 110, a control device 115, at least one data storage unit 120, a display unit 125, an automated data input/output interface 130, a data fusion and processing unit 135, a risk assessment unit 140, a sensor interface 145, an RF/satellite transceiver 150, and a warning message/command data generating unit 155, the individual units and/or devices being interconnected by one or more data/control busses 160.

It should be appreciated that although depicted as separate individual elements, any of the depicted individual units and/or devices may be combinable with other individual units and/or devices, with the functionalities as described below, as combined units and/or devices within the exemplary data fusion center system 105. Further, while envisioned as one or more hard-wired data control busses 160, any data communications paths by which data and/or control inputs may be exchanged between individual units and/or devices, and/or combined units and/or devices, within the exemplary data fusion center system 105, are envisioned. Such data communications paths may include individual wired and/or wireless communications connections, or any combinations of such connections between communicating elements, units and/or devices. Additionally, one or more of the depicted individual elements and/or combination units or devices, as introduced above, and the functionalities of which will be described in more detail below, may be located external to and otherwise in data communication with, the exemplary data fusion center system 105.

In various exemplary embodiments, a user interface 110, when included, may afford a user an opportunity to directly communicate with the data fusion center system 105, or any of the individually-identified units and/or devices, in order to, for example, input information directly to, or extract data directly from, or otherwise control, modify or update the exemplary data fusion center system 105, or any of the individually identified units and/or devices.

In various exemplary embodiments, elements within, or data sources (see FIG. 1) in communication with, the data fusion center system 105 may substantially continuously, or otherwise at discrete intervals, detect a geographic position of a target vehicle. Such detection may be facilitated by collecting planned or actual target vehicle geographic position information from all available sources, as discussed above with reference to FIG. 1. Radar systems, global positioning satellite navigation systems, vehicle detection and monitoring systems and other data sources may encompass available data sources with information that may be received by the data fusion center system 105 via, for example, one or more of an automated data input/output interface 130, a direct sensor interface 145, or an RF/satellite transceiver 150, or by other available means by which target vehicle geographic position data may be provided to the exemplary system 105, to include manual input via the user interface 110. Such detected geographic position information of the target vehicle may include, where appropriate, a vertical reference, i.e., altitude, above a given reference plane. Geographic position information of a target vehicle may be provided (1) directly from the target vehicle, (2) directly from some intermediate monitoring and/or communications node with which the target vehicle is in communication, the intermediate communications node being also in communication with the exemplary data fusion center system 105 via one or more of the available communication paths, or (3) directly from alternative monitoring systems with which the data fusion center system 105 is in direct communication via one or more of the available communication paths. Processing of, for example, geographic position information of the target vehicle, it should be appreciated, may occur internal to the vehicle, at an intermediate monitoring and communication node, at an alternate data source, or within the data fusion center system 105, for example, based on a raw data feed and specifically within the data fusion and processing unit 135.

In various exemplary embodiments, a detected geographic position of a target vehicle, obtained in any of the means discussed above by the data fusion center system 105, may provide one input to the data fusion and processing unit 135. Other inputs to the data fusion and processing unit 135 may include all available, i.e., all-source, data reporting vehicular traffic in a designated area. Such vehicular traffic information may be received from all of the sources discussed above in, for example, paragraphs [0029]-[0034]. It should be appreciated that such all-source data is not intended to be limited to any particular types of data, and/or combination of data sources. Rather, any available data source from which data may be received by the data fusion center system 105 via one or more of the communications paths available to, or in, the data fusion center system 105, that would aid in fusing a complete vehicular traffic picture around a detected geographic position of one or more target vehicles is envisioned. The calculations to determine the vehicular picture is envisioned to be ground-based to allow for a more robust and powerful system to be employed.

In various exemplary embodiments, the data fusion and processing unit 135 may fuse all-source data regarding vehicular traffic, with a specific reference to the detected geographic position of a target vehicle. Where appropriate, such data will include fusion of all-source data in three dimensions with the geographic position of the target vehicle representing a reference point around which a fused picture and/or lay down of vehicular traffic in three dimensions may be centered.

In various exemplary embodiments, a risk assessment unit 140 may reference the fuse target vehicle-centric information regarding vehicular traffic within a specified range of the geographic position of the target vehicle in order to assess potential conflicts between movements of the target vehicle and the vehicular traffic in the vicinity. The risk assessment unit 140 may determine that a risk of collision exists. It should be appreciated that a determination of risk of collision may be based on determining whether a scheme of movement of the target vehicle and the scheme of movement of other vehicular traffic within the vicinity of a geographic position of the target vehicle may predict risk of actual collision between the vehicles absent some evasive maneuvering, or may determine that such schemes of movement of the vehicles under consideration will cause the vehicles to close to within a vehicle-to-vehicle range that is less than some predetermined threshold, i.e., miss distance.

It should be further appreciated that in order to avoid unnecessarily maneuvering a target vehicle, particularly a UAS, from its intended scheme of movement, any predetermined threshold or miss distance must balance an objective of timely providing a warning of risk of collision in order to effect evasive maneuvering of the UAS platform to avoid actual or near collision, while not impeding operation of the UAS to its intended function by unnecessarily maneuvering the vehicle based on any vehicular traffic within the vicinity of the target vehicle.

In various exemplary embodiments, based on an assessment that a conflict and/or risk of collision exists between the target vehicle and other vehicular traffic in the vicinity of the target vehicle, the assessment being output from the risk assessment unit 140, separately from the data fusion and processing unit 135, or otherwise, a warning message may be automatically generated to be immediately transmitted to an operator of the target vehicle. It should be noted that, while the operator of the target vehicle is an intended recipient of such a warning message, other vehicular traffic with which risk of collision exists may also be alerted. A warning message/command data generating unit 155 may be available to generate such a warning message. The generated warning may be in the form of one or more of an auditory warning tone, a visual alert signal, or other sensory input directly to the operator of the vehicle. For remotely piloted vehicles, such as, for example, a UAS, or otherwise, the warning may comprise a formatted text message that may be automatically formatted within the exemplary warning message/command data generating unit 155. Such a textual message, generated by the warning message/command data generating unit 155, or otherwise, may include, for example, an indication of an evasive maneuver that should be undertaken by the operator of the target vehicle to avoid collision with other vehicular traffic in the vicinity of the target vehicle. Further, it should be appreciated that the exemplary warning message/command data generating unit 155 may generate command data to be sent directly to systems in the target vehicle to effect evasive maneuvering in order to reduce risk of collision or to avoid collision between the target vehicle and other vehicular traffic in the vicinity of the target vehicle. In any case, such warnings, transmitted as either warning messages or command data, are intended to reduce an assessed risk of collision between a target vehicle and the other vehicular traffic in the vicinity of the target vehicle and to virtually eliminate any risk of actual collision between the target vehicle and other vehicular traffic in the vicinity.

The warning message/command data generating unit 155 may provide a capability to specifically format the warning message and/or command data to a reception capability of the intended receiver. Any communication capability may be employed that will facilitate most expeditiously transmitting a warning message or command data regarding risk of collision between a target vehicle and other vehicular traffic in the vicinity of the target vehicle, such as, for example, via an automated data input/output interface 130, an RF/satellite transceiver 150 or otherwise via any available communication path to the operator of the target vehicle, or directly to systems within the target vehicle, such as, for example, a T1 data line or POTS.

In the specific application of transmitting such a warning message to a locally-situated, or remotely-located, pilot of one or more UAS platforms, such warning message transmission may occur over any one or more of currently known, or later-developed, data communications capabilities in order to present, in a form usable by the UAS pilot, a warning of risk of collision in a timely enough manner for the UAS pilot to assess the situation and to effect evasive maneuvering to reduce or eliminate risk of collision between a target UAS vehicle and other airborne vehicular traffic in the vicinity of the target UAS vehicle. Such transmission may include any manner of data message to effect the objective up to and including a full three-dimensional target vehicle centered situational awareness display.

It should be appreciated that, where appropriate, a secure data encoder/decoder (not shown) may be incorporated into the data fusion center system 105 in order to facilitate secure data transmission over one or more of the data communications paths available to and from the data fusion center system 105.

It should be appreciated that the ability to collect, fuse and analyze the data within the data fusion center system 105 is envisioned to be complete and fast enough to be able to (1) assess a risk of collision, and (2) when risk of collision is assessed to be present, communicate warning messages and/or command data to an operator of a target vehicle and/or directly to systems within the target vehicle in order to effect evasive maneuvering to reduce or eliminate the assessed risk of collision between the target vehicle and other vehicular traffic in the vicinity. Such capability is intended to be proven, and certifiable, by, for example, any external agency that may currently have, or in the future develop, criteria for such demonstration or certification. For example, in the specific application of employment of UAS platforms in the NAS, the systems and methods according to this disclosure are intended to provide, for example, via an exemplary data fusion center system 105, an ELOS to manned aerial systems.

It should be further appreciated that at least one data storage device 120 may be available to store any manner of traffic information, particularly predictive traffic information, system information, system control information, formatted warning messages, and/or other data input to, or to be output from, the data fusion center system 105, or any other manner of information which may be available to a user via, for example, a user interface 110, an automated data input/output interface 130, or a display unit 125, to facilitate implementing the collision avoidance task that is an objective of the exemplary data fusion center system 105, post event analysis, or to any other beneficial purpose for which such information could be stored.

It should be further appreciated that the data fusion and processing unit 135 and the at least one data storage unit 120 may provide sufficient data storage and processing capacity to facilitate the inclusion of additional features and/or functionalities to be implemented within the data fusion center system 105. Software applications to facilitate, for example, such other functionalities may be pre-stored within the data fusion center system 105, or communicated to the data fusion center system 105 via any of the available communications paths, or otherwise.

Any data storage contemplated for various exemplary embodiments of the disclosed system may be implemented by any appropriate combination of alterable memory or fixed memory. The alterable memory, whether volatile or non-volatile, may be implemented using any one or more of static or dynamic RAM, internal disk drives with associated disk-type medium, hard drives, flash memories or any other like memory medium and/or device. Similarly, fixed memory may be implemented using any one or more of ROM, PROM, EPROM, EEPROM, or compatible disk drive, or any other like memory storage medium and/or device.

It should be appreciated that given the required inputs, from whatever source such inputs may be provided, and across whichever communications paths may most efficiently allow such inputs to be received by the data fusion center system 105, requisite processing within, for example, the control device 115 for controlling functions within the system, the data fusion and processing unit 135 for, for example, fusing and developing a local vehicular traffic picture in the vicinity of a target vehicle, the risk assessment unit 140 for assessing risk of collision, and/or the warning message/command data generating unit 155 for generating for output warnings regarding an assessed risk of collision or commands directly to a target vehicle to effect autonomous evasive maneuvering of the target vehicle to avoid collision, may be implemented through software algorithms, hardware or firmware circuits, or any combination of software, hardware, and/or firmware control and/or processing elements.

It should be further appreciated that, although depicted as an exemplary system 105, and/or individual subsystems and/or units/devices internal to an exemplary system 105, the above described functionalities for storing information, detecting geographic reference positions, in three dimensions if appropriate, executing data fusion and risk of collision analysis, generating for output one or more warning messages and/or control data inputs, and transmitting such warning messages and/or control data inputs, may occur with the applicable system, devices and/or units not being internal to, and/or in any manner integral with, the exemplary data fusion center system 105. Rather, each of the described functionalities of at least a data fusion and processing unit 135, a risk assessment unit 140, and a warning message/command data generating unit 155, with the requisite data communications to facilitate these functionalities, may be implemented as one or more external devices to an exemplary data fusion center system 105. It should be appreciated that each of the one or more devices and/or units, and the exemplary capabilities described as being associated with each of these one or more devices and/or units, may be implemented through any manner of data exchange and communication with the exemplary data fusion center system 105.

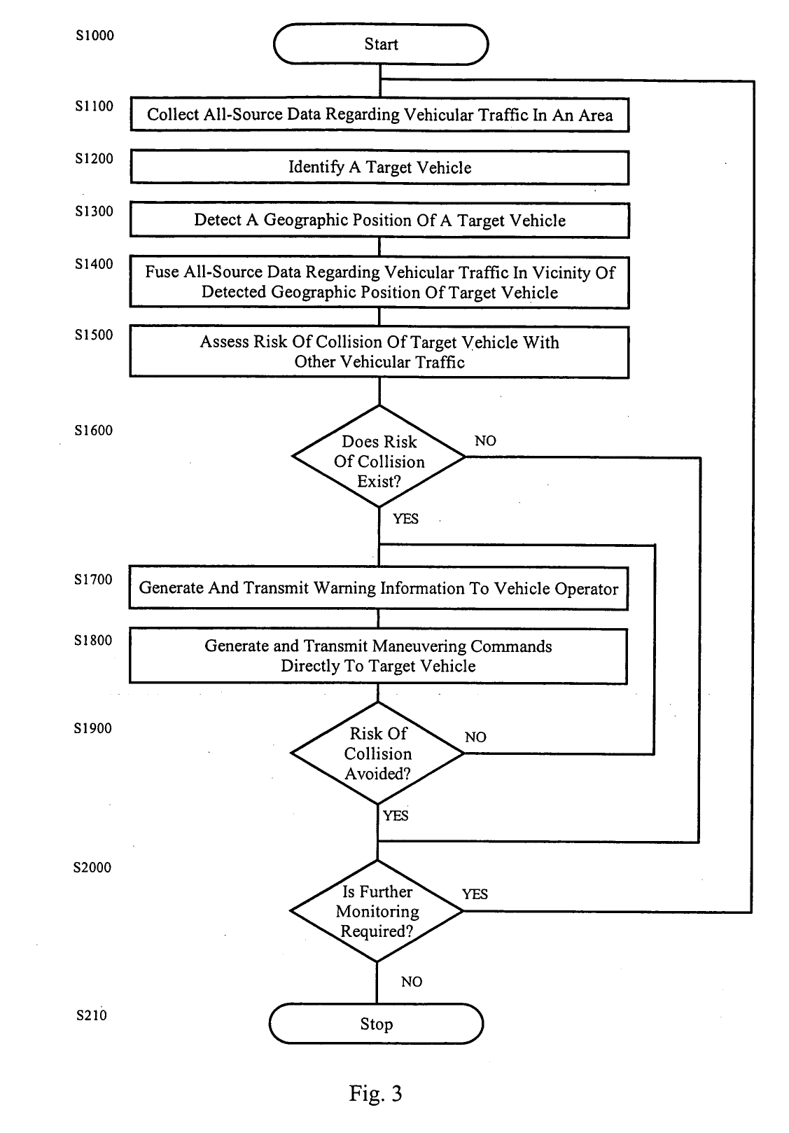

FIG. 3 is a flow chart illustrating an exemplary method for effecting collision avoidance determinations with respect to unmanned aerial systems. As shown in FIG. 3, operation of the method commences at step S1000, and proceeds to step S1100.

In step S1100, all available (“all-source”) data regarding vehicular traffic in an area is collected. Such data collection may occur from one or more of the sources enumerated in any of paragraphs [0029]-[0034] discussed above. The all-source data may be received by a data collection, fusion, analysis and communication system via one or more available communication paths. Such communication paths include all manner of communication paths that may be employed to receive data communicated from one or more data sources via wired and/or wireless means. Operation of the method continues to step S1200.

In step S1200, a target vehicle is identified. Such identification may be based on any manner of data input. The target vehicle may be identified based on a predetermined identification, other predetermined parameters, or based on an input received as part of the collection scheme to collect all-source data regarding the vehicular traffic in an area. Such a target vehicle may be, for example, an identified unmanned aerial system (UAS) being employed in the area for which vehicular traffic data is being collected. Operation of the method continues to step S1300.

In step S1300, a geographic position of the target vehicle is detected and localized. Such geographic position, with respect to aerial vehicles, may be detected in three dimensions. It should be appreciated that detecting a geographic position of the target vehicle may further include detecting and/or identifying a scheme of movement for the target vehicle. Operation of the method continues to step S1400.

In step S1400, the collected all-source data is fused for vehicular traffic in the vicinity of the detected geographic position of the target vehicle. The fusing of such data is intended to compile a representation of vehicular traffic specifically in the vicinity of the detected geographic position of the target vehicle or along the scheme of movement of the target vehicle. The detected geographic position of the target vehicle may represent the center of a three-dimensional data scheme for compiling data regarding vehicular traffic in the vicinity of the target vehicle. It is an objective to make the fusing and assessment schemes according to the exemplary method centered on the target vehicle. Operation of the method continues to step S1500.

In step S1500, an assessment is made regarding conflicts in the geographic positions and/or schemes of movement of the target vehicle with other vehicular traffic in the vicinity of the target vehicle to assess a risk of collision of the target vehicle with any of the other vehicular traffic in the vicinity of the target vehicle. Operation of the method continues to step S1600.

It should be appreciated that the assessment of risk of collision may (1) require assessment of a number of parameters involved in the scheme of movement of the target vehicle as well as varying schemes of movement of other vehicular traffic in the vicinity of the target vehicle; (2) predetermination of an acceptable separation range between any pair of vehicles at a closest point of approach; and (3) a balance in a need to effect maneuvers to maintain safe separation distances between pairs of vehicles and a necessity to not unnecessarily modify a preplanned scheme of movement for the target vehicle, particularly when such target vehicle may be remotely operated, such as, for example, a UAS platform. Operating considerations regarding preplanned vehicular movement of remotely-piloted vehicles may be made in consideration of limited additional fuel payloads, for example, to support random, unnecessary, evasive maneuvering. Such random, unnecessary, evasive maneuvering may be effected if safe separation distances are too large particularly in areas of high-density vehicular traffic.

In step S1600, a determination is made whether a risk of collision between a target vehicle and other vehicular traffic in the area exists. If in step S1600 it is determined that no risk of collision exists, operation of the method proceeds directly to step S2000.

If in step S1600 it is determined that a risk of collision between a target vehicle and other vehicular traffic in the vicinity of the target vehicle exists, operation of the method continues to step S1700.

In step S1700, a warning message may be generated. Such warning message may then be formatted for transmission to an operator of the target vehicle, and to other vehicular traffic in the vicinity of the target vehicle. Operation of the method continues to step S1700.

It should be appreciated that transmission of generated warning messages are intended to be timely enough to provide at least a target vehicle operator with enough time and information to react to an assessed risk of collision by effecting such evasive maneuver as may be necessitated to increase the miss distance between the target vehicle and one or more other vehicles in the vicinity of the target vehicle with which risk of collision exists to an acceptable level.

In consideration of the above, the generated warning message may include, for example, an auditory warning tone, a visual alert signal, or other sensory input directly to the operator of the target vehicle. For remotely piloted vehicles, such as, for example, a UAS, or otherwise, the warning may comprise a formatted text message that may be automatically formatted and include, for example, (1) an indication of an evasive maneuver that should be undertaken by the operator of the target vehicle to avoid collision with other vehicular traffic in the vicinity of the target vehicle, or (2) enough information to quickly generate or modify, for example, a three-dimensional situational awareness display available to the target vehicle operator.

In step S1800, maneuvering commands may be generated for transmission directly to systems within the target vehicle that may command those systems to initiate evasive maneuvering to reduce or otherwise eliminate the assessed risk of collision. Operation of the method continues to step S1900.

In step S1900, a determination is made, particularly because the involved system is now specifically alerted to a risk of collision between a target vehicle and other vehicular traffic in the vicinity of the target vehicle, whether the risk of collision has been avoided. This determination may be made based on an assessment that the miss distance between the target vehicle and the other conflicting vehicular traffic in the vicinity of the target vehicle has now been increased to a point that is above an acceptable threshold. If in step S1900 a determination is made that the risk of collision is avoided, operation of the method continues to step S2000.

If in step S1900 a determination is made that the risk of collision has not been avoided, operation of the method reverts to step S1600 where a further warning message may be generated and transmitted to the operator of the target vehicle, or otherwise, to continue to effect evasive maneuvering, or to further effect evasive maneuvering, to reduce risk of collision between the target vehicle and other vehicular traffic in the vicinity of the target vehicle.

In step S2000, with risk of collision between the target vehicle and other vehicular traffic in the vicinity of the target vehicle avoided, a determination is made whether further monitoring is required. If in step S2000 a determination is made that further monitoring is required, operation of the method reverts to step S1100.

If in step S2000 a determination is made that further monitoring is not required, operation of the method continues to step S2100 where operation of the method ceases.

It should be appreciated that the above identified exemplary method as discussed in paragraphs [0055]-[0071] is intended to be illustrative and not limiting. The steps of collecting, fusing, analyzing and communicating information regarding risk of collision with an objective of collision avoidance between a target vehicle and other vehicular traffic in the vicinity of the target vehicle may be undertaken in myriad ways by a combination of systems that may be located within the vehicles themselves, within intermediate communications nodes which are in communication with the vehicles and otherwise in communication with a centralized data collection, fusion, analysis and communication center, or within such a data collection, fusion, analysis and communication center. In the case of UAS platforms, it is preferable to locate substantially all of the data collection, fusion, analysis and communication capabilities at locations other than onboard the vehicle based on size, weight and power (SWAP) constraints of UAS platforms.

While exemplary embodiments of disclosed systems and methods have been described above, the exemplary embodiments and variations thereof should be viewed as generally illustrative and not limiting, or limited to any specific application or implementation. Various modifications, substitutes or the like may be possible to implement the systems and methods according to this disclosure, and such variations are reasonably contemplated by reference to the above discussed exemplary embodiments.

What is claimed is:

1. A method for effecting collision avoidance in a target vehicle, comprising:
collecting available data regarding vehicular traffic in an area;
identifying a target vehicle;
detecting a geographic position of the target vehicle;
automatically referencing and fusing collected data regarding vehicular traffic in a vicinity of the detected geographic position of the target vehicle;
assessing a risk of collision between the target vehicle and vehicular traffic in the vicinity of the target vehicle; and
automatically transmitting warning information to an operator of the target vehicle based on the assessment.

2. The method of claim 1, wherein at least one of the collecting, detecting, referencing, fusing, assessing or transmitting is undertaken with systems external to and remotely located from the target vehicle.

3. The method of claim 1, wherein the target vehicle is an airborne aerial system and the collecting, detecting, referencing, fusing, assessing or transmitting are undertaken at a remotely located ground-based data fusion center.

4. The method of claim 1, wherein the target vehicle is an airborne aerial system and the data regarding vehicular traffic in the area comprises information regarding other airborne manned aircraft and unmanned aerial systems in the vicinity of the target vehicle.

5. The method of claim 1, wherein the target vehicle is an airborne aerial system and collecting available data regarding vehicular traffic in an area comprises collecting data from at least one of unmanned aerial system control centers, unmanned aerial systems, manned aerial vehicles, satellite-sensed data sources available via satellite communications from one or more satellites, radar data available from fixed and/or mobile radar sites, or other applicable data regarding aerial traffic in a specific area available from other data sources.

6. The method of claim 1, wherein the target vehicle is an airborne aerial system, the collected available data regarding vehicular traffic in an area including altitude information, the method further comprising detecting an altitude of the target vehicle including the altitudes of the target vehicle and the vehicular traffic in the assessment of risk of collision.

7. The method of claim 1, further comprising transmitting command data directly to the target vehicle to effect evasive maneuvering of the target vehicle to avoid collision based on the assessment.

8. The method of claim 1, wherein the warning message is presented to the operator of the target vehicle by at least one of an auditory warning tone, a visual alert signal or another sensory input warning device.

9. The method of claim 1, wherein the warning message is a formatted text message, the method further comprising automatically formatting the warning message and automatically transmitting the warning message to the operator of the target vehicle.

10. The method of claim 1, wherein the warning message includes at least one of an indication of an evasive maneuver that should be undertaken by the operator of the target vehicle to avoid collision with other vehicular traffic in the vicinity of the target vehicle or a display of a target vehicle-centric three-dimensional situational awareness laydown that provides such indication.

11. A computer-readable storage medium on which is recorded a program for causing a computer to implement the method of claim 1.

12. A system for effecting collision avoidance in a target vehicle, comprising:
a data fusion and processing unit that at least one of collects available data regarding vehicular traffic in an area, identifies a target vehicle, detects a geographic position of the target vehicle, or automatically references and fuses collected data regarding vehicular traffic in a vicinity of a detected geographic position of a target vehicle;
a risk assessment unit that assesses a risk of collision between the target vehicle and vehicular traffic in the vicinity of the target vehicle;
a warning message generating unit that automatically generates warning information; and
a transmitter that automatically transmits generated warning information to an operator of the target vehicle based on the assessment.

13. The system of claim 12, wherein at least one of the collecting, detecting, referencing, fusing, assessing or transmitting is undertaken with systems external to and remotely located from the target vehicle.

14. The system of claim 12, wherein the target vehicle is an airborne aerial system and the collecting, detecting, referencing, fusing, assessing or transmitting are undertaken at a remotely located ground-based data fusion center.

15. The system of claim 12, wherein the target vehicle is an airborne aerial system and the data regarding vehicular traffic in the area comprises information regarding other airborne manned aircraft and unmanned aerial systems.

16. The system of claim 12, wherein the target vehicle is an airborne aerial system and collecting available data regarding vehicular traffic in an area comprises collecting data from at least one of unmanned aerial system control centers, unmanned aerial systems, manned aerial vehicles, satellite-sensed data sources available via satellite communications from one or more satellites, radar data available from fixed and/or mobile radar sites, or other applicable data regarding aerial traffic in a specific area available from other data sources.

17. The system of claim 12, wherein the target vehicle is an airborne aerial system, the collected available data regarding vehicular traffic in an area including altitude information, and the data fusion and processing unit detects an altitude of the target vehicle, and the risk assessment unit includes the altitudes of the target vehicle and the vehicular traffic in the assessment of risk of collision.

18. The system of claim 12, wherein the warning message generating unit generates command data that the transmitter in turn transmits directly to the target vehicle to effect evasive maneuvering of the target vehicle to avoid collision based on the assessment.

19. The system of claim 12, wherein the warning message is presented to the operator of the target vehicle by at least one of an auditory warning tone, a visual alert signal or another sensory input warning device.

20. The system of claim 12, wherein the warning message is a formatted text message, the warning message generating unit automatically formatting the warning message and the transmitter automatically transmitting the warning message to the operator of the target vehicle.

21. The system of claim 12, wherein the warning message includes at least one of an indication of an evasive maneuver that should be undertaken by the operator of the target vehicle to avoid collision with other vehicular traffic in the vicinity of the target vehicle or a display of a target vehicle-centric three-dimensional situational awareness laydown that provides such indication.
